(19) United States
(12) Patent Application Publication
(10) Pub. No.: US 2004/0121043 A1
(43) Pub. Date: Jun. 24, 2004

(54) Tocopherol concentrates and method for producing same

(76) Inventor: Dariush Behnam, Rossdorf (DE)

Correspondence Address: JACOBSON HOLMAN PLLC, 400 SEVENTH STREET N.W., SUITE 600, WASHINGTON, DC, 20004, US

(21) Appl. No.: 10/323,732

(22) Filed: Dec. 20, 2002

(51) Int. Cl. A23L 1/30

(52) U.S. Cl. 426/72

(57) ABSTRACT

Disclosed is an easily water soluble and clear tocopherol concentrate which includes a polysorbate, preferably polysorbate 20 which allows to obtain a tocopherol concentration in the concentrate of up to approximately 20% by weight. Also described is a method for producing such concentrate including dissolving the tocopherol in that polysorbate which is warmed to approximately 50° C. to 85° C. before the addition of tocopherol.

The invention refers to tocopherol concentrates which are adapted to be used as food supplements and/or as preservatives for food, and to a method for their production.

Fat soluble compounds such as Vitamin E are absorbed in the intestine dependent on the presence of bile salts and enzymes of the pancreas. The absorption process is preceded by a procedure of the so called micelle formation in the intestine which is necessary for packing fat-soluble compounds which thereby may overcome various barriers of the mucous layers in the intestine.

However, in case the secretion of bile salts or of pancreatic enzymes is disturbed the result is a so-called mal-digestion or mal-absorption of the fat-soluble compounds. The best example for this effect is the disease cystic fibrosis in which, due to non-availability of pancreatic enzymes, fat-soluble compounds can only be absorbed to a very low degree.

The peculiarity of the absorption of fat soluble micro-nutrients is evidenced by the fact that absorption always rises when fat is offered at the same time. Fat favours, on the other hand, the discharge of bile acids and pancreatic enzymes and also the formation of micelles which then contain the fat soluble micro-nutrients already mentioned.

If the fat soluble compounds are absorbed into the cells of the intestine, they are present there in a free form, i.e. they are not bound to micelle components. In this free form, they are then made water-soluble again, in that they are built into the intestinal cells (lipoproteins-chylomicrones) and then passed via the large lymph ducts into the blood.

Therefore, in order to absorb lipophilic compounds, the organism must make them water-soluble in two steps. The first step is carried out in the intestine by the formation of the micelles from which the substance is then set free again in the intestine cell; the second step is the formation of lipoproteins for transport in the blood. It therefore may be understood that lipophilic substances which have been made water-soluble (clear solutions), but not those which are merely dispersed in a watery medium (cloudy solutions) can be absorbed more quickly and efficiently by the organism than the original lipophilic substance.

There is only very little data available on the bio-availability of lipophilic micro-nutrients (clear solutions) which have been made water-soluble. One procedure for testing the bio-availability of such compounds is the so-called in-vitro dissolution procedure. Such procedure establishes to what extend a compound is dissolved in the watery compartment or to what extend it is released from a definite galenic preparation form. It is known from U.S. Pat. No. 6,048,566 that Q₁₀ which has been made water-soluble is released to 100%, contrary to Q₁₀ from oily solutions or dispersions (cloudy solutions). This means, however, that the water soluble Q₁₀ thus applied already exists in higher concentrations in a free form in the intestinal lumen.

It is therefore an object of the invention to improve the bio-availability of tocopherols, especially α-tocopherol by creating a water soluble concentrate having high tocopherol-concentration and to improve the preservative effect of tocopherol when added to food preparations.

To this end the invention provides for a tocopherol concentrate which contains up to approximately 20% by weight of tocopherol and polysorbate 20. As contrasted to different polysorbates utilising polysorbate 20 for dissolving tocopherol results in a higher tocopherol concentration in the concentrate.

The utilisation of polysorbates is governed by the so-called “Quantum-satis” rule according to which the allowable quantity of polysorbates in food may be only as high as technically necessary. Therefore, it is another object of the invention to utilise the least quantity of polysorbates when producing the concentrates according to the invention so that the ADI values (acceptable daily intake) for the polysorbates according to JECFA (Joint FAO/WHO Expert Committee on Food Additives) and SCG substances (Scientific Committee on Food (EU)) are remarkably lowered.

According to the invention the concentrate includes a solution of a tocopherol and/or of one or more of its derivatives in a polysorbate with a concentration of the tocopherol of up to approximately 20% by weight. Such concentrate is absolutely clear and permantly water soluble. The smallest units (micelles) of the concentrate have a particle size of at most 30 nm including just seven molecules of tocopherol. The concentrate is chemically, microbiologically, mechanically and thermally stable. The concentrate may be used directly and without any problem and without any additional steps as a food supplement or as a preservative for food. Particularly, the concentrate is stable in gastric acid. The concentrate enhances the bio-availability of tocopherol ingredients, which is many times higher and faster than conventional (micro- and nano-) emulsions. The concentrate according to the invention renders a participation of the bile acids superfluous during the resorption in the intestinal region (small intestine).

According to an embodiment of the invention, a solution of coenzyme Q₁₀ in polysorbate 80 is added to the concentrate. Such addition of Q₁₀ raises the quantity of tocopherol which can be dissolved in polysorbate 80.

If the tocopherol concentrate is to be used as a food supplement, it is preferred to select α-tocopherol, which has the highest anti-oxydative capacity. For a utilisation of tocopherol as a preservative for food it is recommended to select the natural mixture of the tocopherol stereoisomers.

According to the invention, derivatives of tocopherol may be utilised in the concentrate according to the invention. Examples of such derivatives are α-tocopherol acetate and α-tocopherol hydrogen succinate. The mass ration of α-tocopherol to polysorbate 20 is preferably selected to 1:4.

The method for preparing the concentrate according to the invention provides for dissolving a quantity of tocopherol or a derivative thereof in a surplus of a polysorbate which is warmed to a temperature ranging from approximately 40° C. to approximately 85° C., thereafter the solution is stirred until it becomes clear which needs a period of time of approximately five to ten minutes. The concentrate obtained thereby is to full extend soluble in water after being cooled down to room temperature or twenty degrees centigrade. Preferably, a solution of coenzym Q₁₀ in warm polysorbate, advantageously in polysorbate 80 is added to the concentrate according to the invention. For dissolving the tocopherol, best results i.e. higher concentration is obtained when utilizing polysorbate 20.

The invention and preferred embodiments thereof are described hereinafter by giving some examples.

### a) α-Tocopherol Concentrate

The α-tocopherol concentrate contains α-tocopherol or derivatives of it and a polysorbate. As derivatives, α-tocopherol acetate or also α-tocopherol hydrogen succinate may be utilized. The concentrate may be diluted with water as required so that an aqueous solution of Vitamin E can be easily obtained from the concentrate. Consequently, the bio-availability of Vitamin E is substantially improved.

Water-soluble Vitamin E may also be employed to advantage in the cosmetic field in the preparation of, for example, two-component ointments. The concentrate content in one component dissolves the fatty protective layer on the skin so that the Vitamin E in the second component is readily taken up by the skin cells.

The concentrate according to this invention is also suitable as an additive in drinks, nutritional supplements and medicaments based on water or syrup. The practical mass ratio of α-tocopherol to Polysorbate 20 is one to four (1:4).

As a polysorbate, polyoxyethylene sorbitane monolaurate (polysorbate 20) may be used. In one of the preferred embodiments, the concentrate according to the invention contains between approximately 0.1 gram and about 220 gram—preferably 200 gram—of α-tocopherol or one or more of its derivatives per 1000 gram of concentrate. Furthermore, the concentrate may contain between about 780 gram and 999.9 gram—preferably 800 gram—of polysorbate 20 or polysorbate 80 per kilogram of concentrate.

The concentrate according to the invention may be obtained by introducing α-tocopherol into heated polysorbate 20 and stirred for a period of 5 to 10 minutes until an homogeneous and clear mixture is produced. The temperature of the polysorbate may be selected between approximately 50° C. and about 85° C. The concentrate can be easily dissolved in water after cooling.

### b) Example of Producing a Transparent α-tocopherol Concentrate

As an example of the production of the concentrate according to the invention about 800 gram of polysorbate 20 are heated to about 80 degrees Celsius. About 200 gram of α-tocopherol are introduced into the heated mass and the resulting mixture is stirred evenly under heat for about 5 minutes until a homogeneous and clear mixture is obtained. The transparency is retained without limitation after cooling to room temperature. The resulting concentrate can be easily dissolved in warm water at about 20 degrees Celsius after brief stirring without turbidity or sedimentation.

50 milligram of the concentrate produced in this manner contains 10 milligram of vitamin E, corresponding to the average daily intake, and 40 milligram of polysorbate 20, corresponding to eight percent of the ADI value for polysorbate. If polysorbate 80 is used as the solubiliser for α-tocopherol, then a mass ratio of α-tocopherol to polysorbate 80 of at least 1:19 is necessary in the concentrate for obtaining a homogeneous and clear concentrate. Due to the quantum satis rule mentioned, a lower content of α-tocopherol in polysorbate 80 is not recommended if the concentrate is to be added to a nutritional supplement or a drink in view of the excess polysorbate 80. When administering e.g. 10 milligrams of vitamin E by taking up the vitamin E concentrate containing polysorbate 80 having a vitamin E to polysorbate quantity ratio of one to nineteen (1:19), 190 milligram of polysorbate 80 are simultaneously taken up. This amount corresponds to 38 percent of the ADI value and therefore is 4.75 times higher than if the vitamin E polysorbate 20 concentrate described above had been used.

Adding coenzyme Q₁₀ to the α-tocopherol concentrate according to the invention is to be recommended, since with this combination the shelf-life of the concentrate is extended, because the vitamin E provides a protective function on the coenzyme Q₁₀.

### c) α-Tocopherol Coenzyme Q₁₀ Concentrate

If it is desired to add coenzyme Q₁₀ to the α-tocopherol concentrate produced as described in Item a), a coenzyme Q₁₀ concentrate is first obtained effectively as follows:

About 222 gram of coenzyme Q₁₀ are added to 778 gram of Polysorbate 80 which is heated to about 85 degrees Celsius and the resulting mixture stirred for about 5 minutes under heat until a homogeneous, transparent, viscous concentrate is produced. After cooling to about 40 degrees Celsius, this concentrate is initially firm like a cream and non-transparent. Once it is heated to about 60 degrees Celsius, it becomes viscous again and transparent and can be diluted as required with water heated to about 40 degrees Celsius after brief stirring. In this manner a coenzyme Q₁₀ concentrate is obtained from which a kilogram contains about 222 gram of coenzyme Q₁₀.

Coenzyme Q₁₀ also has an advantageous effect on the water-solubility of α-tocopherol in Polysorbate 80. Whereas α-tocopherol can only be dissolved in polysorbate 80 optimally in a stable manner in a quantity ratio of 1:19, this ratio can be increased to 2:16.8 when coenzyme Q₁₀ is simultaneously dissolved, a fact which can become important in conjunction with the “quantum satis” rule. The following example illustrates this effect.

About 740 gram of polysorbate 80 is heated to about 100° C. and then about 212 gram of coenzyme Q₁₀ and about 44 gram of α-tocopherol are added and the resulting mixture (about 996 gram) is stirred while maintaining the temperature until a homogenous, transparent mixture is produced. An α-tocopherol—coenzyme Q₁₀ concentrate produced in this manner can be diluted as required with water heated to about 30 degrees Celsius to form a clear, stable mixture.

### d) Example of Producing a Non-transparent α-tocopherol Concentrate

An example of the production of a concentrate of tocopherol which does not lead to the advantageous qualities of the invention: About 330 gram of polysorbate 20 are heated to about 50° C. In the heated mass about 230 gram of D-α-tocopherol acetate is introduced and the resulting mixture stirred evenly under heat for about 5 minutes until a homogenous mixture is produced. Then about 440 gram of water is added to this mixture and the resulting mix (1 kilogram) is again stirred evenly for about 5 minutes until a homogeneous mixture is produced. The concentrate produced in this manner is viscous, bright, non-transparent and is easily diluted in water, for example with a ratio of one to two thousand (1:2000).

With the concentrate produced in the manner described above, in contrast to the transparent concentrate described under Item b), no solution is involved, but rather an emulsion which after diluting with water, e.g. in a ratio of one to two thousand (1:2000), appears clear when observing the surface, but exhibits turbidity after heating (e.g. during pasteurization) or the addition of gastric acid, indicating that, in contrast to the transparent concentrate described in Item a₁) above, this liquid does not involve a stable solution.

If polysorbate 80 instead of polysorbate 20 is used as an alternative for the production of the transparent α-tocopherol concentrate described in the above mentioned item b), then the concentrate obtained in this manner is firm like wax at room temperature, is difficult to process without intermediate thermal treatment and, after dilution with water, e.g. in a ratio of one to two thousand (1:2000), leads to a slightly turbid end product.

What is claimed is:

1. A water-soluble clear concentrate of a tocopherol and/or its derivatives which comprises a solution of tocopherol selected from the group of α-tocopherol, β-tocopherol, γ-tocopherol, δ-tocopherol or a natural mixture of tocopherol or its derivates in a polysorbate, preferably a polysorbate 20 for obtaining a concentration of the tocopherol in the solution of up to approximately 20% by weight.

2. A concentrate according to claim 1 wherein the solution contains additionally a quantity of ubichinon Q₁₀ dissolved in a surplus of polysorbate 80.

3. A concentrate according to claim 1 wherein the mass ration of α-tocopherol to polysorbate 20 amounts to approximately 1:4.

4. A concentrate according to claim 2 wherein tocopherol is mixed with polysorbate 80 and the mass ration of α-tocopherol to polysorbate 80 amounts to approximately 1:19.

5. Method for producing a concentrate according to claim 1 wherein a tocopherol and/or a derivative thereof are dissolved in a surplus of a warmed polysorbate, and wherein the warmed solution is stirred until the solution resumes clarity.

6. Method according to claim 5 wherein polysorbate 20 is selected as polysorbate.

7. Method according to claim 5 wherein the polysorbate is warmed to a temperature of approximately 40° C. to approximately 85° C. before the introduction of tocopherol.

8. Method according to claim 5 wherein ubichinon Q 10 dissolved in a surplus of a warm polysorbate 80, the solution being stirred until clarity of the solution is obtained, and adding such solution to the warmed tocopherol concentrate.

9. Method according to claim 8 wherein the mass ratio of coenzym Q₁₀ to polysorbate 80 amounts to approximately to 1:19.
